(19) United States
(12) Patent Application Publication
(10) Pub. No.: US 2006/0110194 A1
(43) Pub. Date: May 25, 2006

(54) System and method for creating document effects

(76) Inventors: James R. Emmert, Corvallis, OR (US); Charles Evans, Corvallis, OR (US)

Correspondence Address: AVAGO TECHNOLOGIES, LTD., P.O. BOX 1920, DENVER, CO, 80201-1920, US

(21) Appl. No.: 10/997,021

(22) Filed: Nov. 23, 2004

(51) Int. Cl. G03G 15/20

(52) U.S. Cl. 399/341

(57) ABSTRACT

A system and method for printing a document having one or more document effects. The method comprises determining an electrostatic image to be applied to a sheet of paper that corresponds to an effects pattern, applying an effect toner to the sheet of paper corresponding to the electrostatic image, and fusing the effect toner to the sheet of paper. Typically, the effect toner is applied after a non-effect toner and/or a non-effect ink have been applied to the sheet of paper. Thus, the non-effect toner/ink provides the content of the sheet of paper while the clear toner provides an effect, such as watermarking, UV-reflection, etc. Such a system is well suited for creating and reproducing documents with effects because large industrial printers are not required to produce the document effects.

### BACKGROUND OF THE INVENTION

Laser printers and inkjet printers are commonly used in office settings and smaller document production facilities that require small scale and often numerous printing jobs for day-to-day business. Such small scale, quick demand, and non-repetitive document reproductions are not cost effective to be printed using industrial or commercial-enterprise printing machines such as those found at book publishing companies, newspaper outfits, and generally large-scale document production facilities. Laser and inkjet printers have melded into office settings to provide companies with the ability to produce sharp-looking, high-quality documents at a moment's notice.

Some kinds of documents, however, have proven to be difficult to reproduce on laser and inkjet computers. While conventional laser and inkjet printers are well suited to producing documents of printed subject matter, conventional laser and inkjet printers are not as well suited for producing artwork, photographs, and the like. More specifically, laser and inkjet printers are not well suited for producing particular photographic or artistic effects, such as glossy, matte, or satin finish. Furthermore, other effects such as watermarking, three-dimensional effects (3-D), and holography are also difficult, if not impossible, to effectively reproduce using conventional laser and inkjet printers.

FIG. 1 is a side view diagram of a conventional laser printer 170 that will be used to illustrate the typical workings of a conventional laser printer 170. Although an inkjet printer is not depicted in FIG. 1 or in any other figure, the concepts and limitations of a conventional inkjet printer are similar to those of the conventional laser printer 170.

The conventional laser printer 170 operates on the principle of static electricity. Briefly, by using a laser 184 to create specific patterns of static electricity on a rotating drum 181, print may be applied to a sheet of paper according to the specific pattern created. Thus, by controlling the laser 184 in precise detail, virtually anything can be printed to paper by charging the rotating drum 181 with static electricity. Although the workings of a laser printer in well known in the industry, the laser printing concept is described in more detail below.

The laser printer 170 engages and maneuvers paper through a series of pulleys 192 and a belt 191. When a document is to be printed, the belt 191 engages a sheet of paper from a paper tray 180 and begins maneuvering the paper toward the rotating drum 181. The rotating drum 181 is then prepared for receiving a pattern of static charge. Initially, the rotating drum 181 is imparted with a total positive charge by a charge corona wire 187, a wire with an electrical current running through it. Some laser printers (not shown) use a charged rotating drum 181 instead of a charge corona wire 187, but the principle of imparting a total positive charge to the rotating drum 181 is the same.

As the surface of the rotating drum 181 revolves past the charge corona wire 187, a laser 184 is focused, via a focusing mirror system 183, across the surface of the rotating drum 181 to discharge certain points according to the specific pattern. In this way, the laser 184 “draws” the letters and images to be printed as a pattern of electrical charges, i.e., an electrostatic image, right on the surface of the rotating drum 181. In other conventional laser printers (not shown), the charges may be reversed, i.e., a positive electrostatic image on a negative background.

After the electrostatic image is imparted to the rotating drum 181, the rotating drum 181 is coated with positively charged toner, most typically a fine, black powder. The toner is applied from a toner roller 182 that includes a toner reservoir. The toner, which typically has a positive charge, clings to the negative discharged areas (the words or images) of the rotating drum 181, but not to the positively charged areas (the background).

With the toner pattern applied according to the electrostatic image, the rotating drum 181 continues rotating and rolls over a sheet of paper, which is moving along the belt 191 below. Before the paper rolls under the rotating drum 181, it is imparted with a negative charge by a transfer corona wire 194 (sometimes called charged roller). The negative charge imparted to the paper is stronger than the negative charge of the electrostatic image imparted to the rotating drum 181 by the laser 184. Thus, when the paper engages the rotating drum, the positively charged toner is then attracted to the more negatively charged paper, in essence, transferring the electrostatic image from the rotating drum 181 to the paper. Since the paper is moving at the same speed as the drum, the paper picks up the image pattern exactly. To keep the paper from clinging to the rotating drum 181, the paper is discharged by a detac corona wire 195 immediately after the toner is transferred. The rotating drum 181 continues rotating, now without toner but still with the electrostatic pattern, until the rotating drum 181 surface passes the discharge lamp 188. Bright light from the discharge lamp 188 exposes the entire rotating drum 181 surface, thereby erasing the electrostatic image. The rotating drum surface is then ready to start the process again by passing the charge corona wire 187, which reapplies the positive charge.

The paper, now having toner applied according to the electrostatic image, passes through a fuser 186 which is typically a pair of heated rollers. As the paper passes through the fuser 186, the loose toner powder melts, fusing with the fibers in the paper to create a printed document. The paper, now a printed document, is then rolled along the belt 191 to the output tray 185.

The laser printer 170 includes a controller 190 that is able to receive data from an outside source, e.g., a computer or a portable media card, and store the data in a printing buffer (not shown) and the interpret the data (which corresponds to a document) into an electrostatic image to be imparted by the laser 184. The controller 190 typically communicates with a computer system via standard, well-known protocols such as through parallel communications ports and/or universal serial bus ports.

As was discussed briefly above, conventional laser printers are not well suited for producing particular photographic or artistic effects, such as glossy, matte, or satin finish. Furthermore, other effects such as watermarking, three-dimensional effects (3-D), and holography cannot be created using conventional laser and inkjet printers. This is because the toner is typically a colored powder, most often black. Color laser and inkjet computers are able to reproduce colors on a printed document, but doing so uses a large amount of toner or ink when printing. As will become more prevalent in the detailed description of the invention below, other document finishing techniques are also not able to be accomplished with conventional laser and inkjet printers.

### SUMMARY OF THE INVENTION

An embodiment of the invention is directed to a system and method for printing a document having one or more document effects. The method comprises determining an electrostatic image to be applied to a sheet of paper that corresponds to an effects pattern, applying an effect toner to the sheet of paper corresponding to the electrostatic image such that the effect toner is operable to yield an effect when fused to the sheet of paper and fusing the effect toner to the sheet of paper. Typically, the effect toner is applied after a non-effect toner and/or a non-effect ink have been applied to the sheet of paper. Thus, the non-effect toner/ink provides the content of the sheet of paper while the effect toner provides an effect, such as watermarking, UV-reflection, etc.

Such a system is well suited for creating and reproducing documents with effects because large industrial printers are not required to produce the document effects. Laser printers may use an effect toner cartridge to apply a clear toner to a sheet of paper in order to realize the document effects. As a result, small-number runs or single document productions requiring specific document effects may be accomplished using small commercial-size desktop printers.

Furthermore, graphics and art may also be produced using small commercial-size desktop printers as applying finish toner may also yield document finishes such as glossy, matte, or satin. Such document finishes produce a sheet of paper that realizes typical art techniques and finishes. Since the document finishes and effects may be produced for short-runs and single document productions, time and money are saved by not having to use large industrial-size printing machines.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a side view diagram of a conventional laser printer that will be used to illustrate the typical workings of a conventional laser printer;

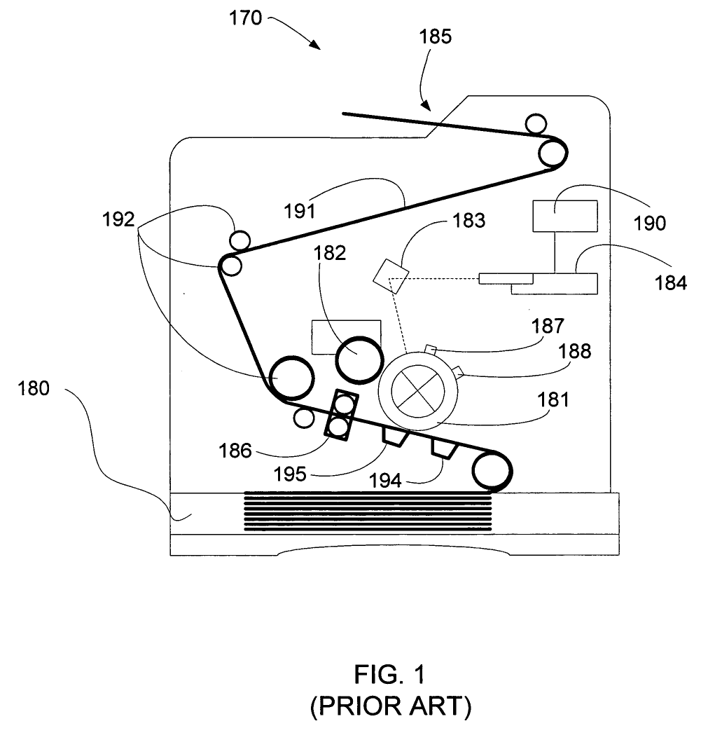

FIG. 2 is a block diagram of a suitable computing environment in which some embodiments of the invention may be implemented;

FIG. 3 is a diagram of a portion of the laser printer of FIG. 2 in the process of imparting toner to a sheet of paper according to an embodiment of the invention; and

FIG. 4 is an isometric view of a sheet of paper having underlying content and document effects that me be printed using the printer of FIG. 2 according to an embodiment of the invention.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

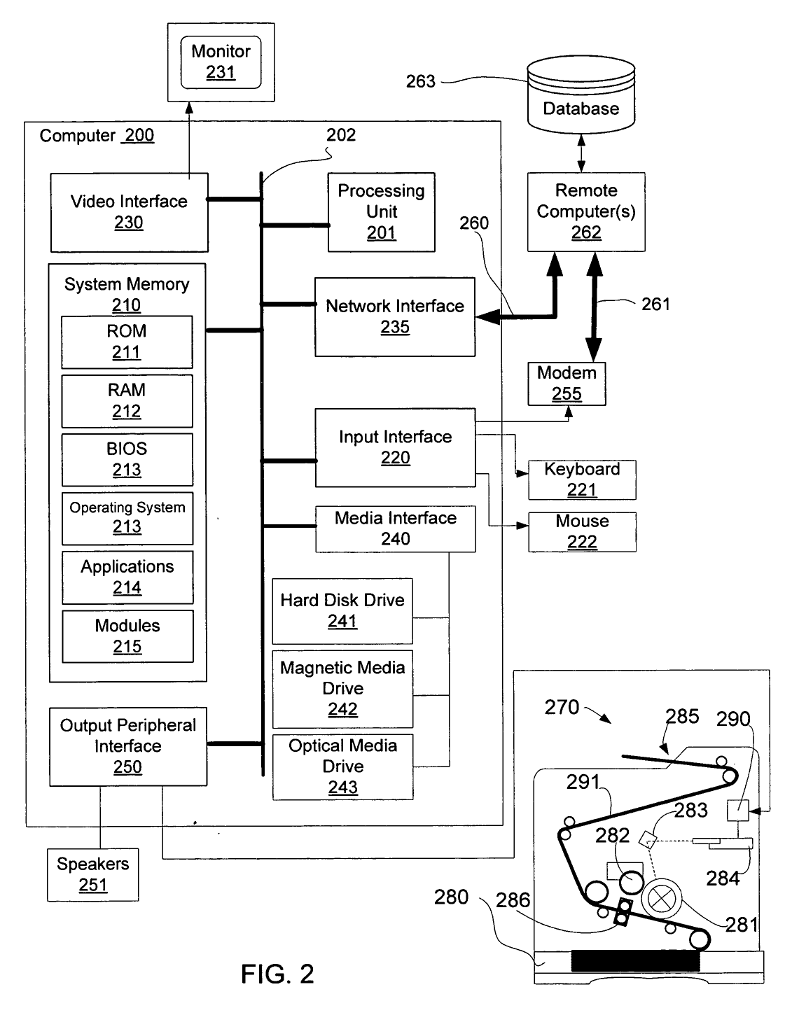

FIG. 2 and the following discussion are intended to provide a brief, general description of a suitable computing environment in which some embodiments of the invention may be implemented. Generally, program modules include routines, programs, objects, components, data structures, etc. that collectively perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 2, an exemplary system for implementing the invention includes a general purpose computing device in the form of a conventional personal computer 200, including a processing unit 201, a system memory 210, and a system bus 202 that couples various system components including the system memory 210 to the processing unit 201. The system bus 202 may be any of several types of bus structures including a memory bus or memory controller, a peripheral bus, and a local bus using any of a variety of bus architectures. The system memory 210 includes read only memory (ROM) 211 and random access memory (RAM) 212. A basic input/output system (BIOS) 213, containing the basic routines that help to transfer information between elements within the personal computer 200, such as during start-up, is stored in the system memory 210. The system memory 210 may further include program applications 214 and program modules 215.

The personal computer 200 further includes a hard disk drive 241 for reading from and writing to a hard disk (not shown), a magnetic media drive 242 for reading from or writing to a removable magnetic disk (not shown), and an optical media drive 243 for reading from or writing to a removable optical disk (not shown) such as a CD ROM or other optical media. The hard disk drive 241, magnetic media drive 242, and optical media drive 243 are connected to the system bus 202 by one or more media interfaces 240 (only one shown). The drives and their associated computer-readable media provide both volatile and nonvolatile storage of computer readable instructions, data structures, program modules and other data for the personal computer 200.

Although the exemplary environment described herein employs a hard disk 241, a removable magnetic disk 242 and a removable optical disk 243, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk 241, magnetic disk 242, optical disk 243, ROM 211 or RAM 212, including an operating system, one or more application programs, other program modules, and program data, all of which are not shown). A user may enter commands and information into the personal computer 200 through input devices such as a keyboard 221 and pointing device 222. Other input devices (not shown) may include a microphone, joystick, game pad, satellite dish, scanner, or the like. These and other input devices are often connected to the processing unit 201 through an input interface 220 that is coupled to the system bus 202. The input interface 220 may be a serial port, a parallel port, a game port, a universal serial bus (USB) or any other interface. A monitor 231 or other type of display device may also be connected to the system bus 202 via an interface, such as a video interface 230. One or more speakers 251 may also be connected to the system bus 202 via an interface, such as an output peripheral interface 250. In addition to the monitor and speakers, a personal computer 200 typically includes other peripheral output devices, such as printer 270 which is described in greater detail below.

The personal computer 200 may operate in a networked environment using logical connections to one or more remote computers, such as remote computer 262. The remote computer 262 may be another personal computer, a server, a router, a network PC, a peer device or other common network node, and typically includes many or all of the elements described above relative to the personal computer 200, although only a memory storage device, such as a database 263 has been illustrated in FIG. 2. The logical connections depicted in FIG. 2 include a local area network (LAN) 260 and a wide area network (WAN) 261. Such networking environments are commonplace in offices, enterprise-wide computer networks, intranets and the Internet. As depicted in FIG. 2, the remote computer 262 communicates with the personal computer 200 via the local area network 260 via a network interface 235. The personal computer may also communicate with the remote computer 262 through the wide area network 261 via a modem 255 or other remote communications device.

When used in a LAN networking environment, the personal computer 200 is connected to the local network 260 through the network interface or adapter 235. When used in a WAN networking environment, the personal computer 200 typically includes a modem 255 or other means for establishing communications over the wide area network 261, such as the Internet. The modem 255, which may be internal or external, is connected to the system bus 202 via the input interface 220. In a networked environment, program modules depicted relative to the personal computer 200, or portions thereof, may be stored in the remote memory storage device. It will be appreciated that the network connections shown are exemplary and other means of establishing a communications link between the computers may be used.

The printer 270 operates similar to the conventional printer 170 described above. In one embodiment, the printer 270 is a laser printer 270 and engages and maneuvers paper through a series of pulleys and a belt 291. When a document is to be printed, the belt 291 engages a sheet of paper from a paper tray 280 and begins maneuvering the paper toward a rotating drum 281. The rotating drum 281 is then prepared for receiving a pattern of static charge. Initially, the rotating drum 281 is imparted with a total positive charge by a charge corona wire (not shown in detail), a wire with an electrical current running through it.

As the surface of the rotating drum 281 rotates further, a laser 284 is focused, via a focusing mirror system 283, across the surface of the rotating drum 281 to discharge certain points according to the specific pattern. In this way, the laser 284 “draws” the letters and images to be printed as a pattern of electrical charges, i.e., an electrostatic image, right on the surface of the rotating drum 281.

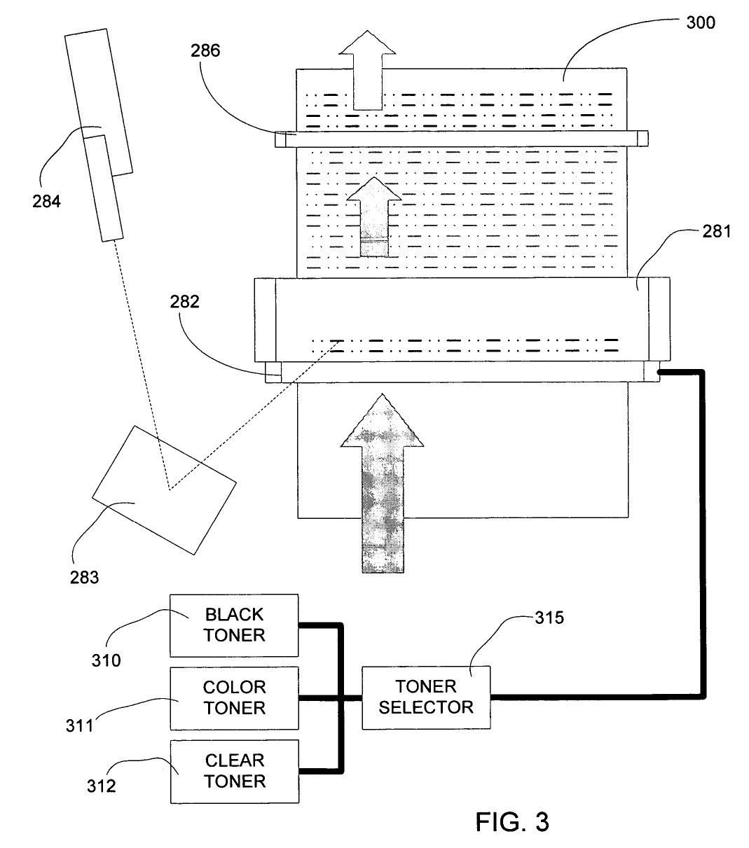

After the electrostatic image is imparted to the rotating drum 281, the rotating drum 281 is coated with positively charged toner which may be a black toner, a colored toner, or a clear toner. The aspects of applying different kinds of toner are described below with respect to FIG. 3. The toner is applied from a toner roller 282 that may include a toner reservoir. Since the toner typically has a positive charge, the toner clings to the negative discharged areas of the rotating drum 281, but not to the positively charged areas.

With the toner pattern applied according to the electrostatic image, the rotating drum 281 continues rotating and rolls over a sheet of paper, which is moving along the belt 291 below. Before the paper rolls under the rotating drum 281, it is imparted with a negative charge by the transfer corona wire (not shown in detail). The negative charge imparted to the paper is stronger than the negative charge of the electrostatic image imparted the rotating drum 281 by the laser 284. Thus, when the paper engages the rotating drum 281, the positively charged toner is then attracted to the more negatively charged paper, in essence, transferring the electrostatic image from the rotating drum 281 to the paper. Since the paper is moving at the same speed as the drum, the paper picks up the image pattern exactly. To keep the paper from clinging to the rotating drum 281, the paper is discharged by a detac corona wire (not shown in detail) immediately after the toner is transferred. The rotating drum 281 continues rotating, now without toner but still with the electrostatic pattern, until the rotating drum 281 surface passes the discharge lamp (not shown in detail) in order to erase the electrostatic image. The rotating drum 281 surface is then ready to start the process again.

The paper, now having toner applied according to the electrostatic image, passes through a fuser 286 which may be a pair of heated rollers. As the paper passes through the fuser 286, the loose toner powder melts, fusing with the fibers in the paper. The paper, now a printed document, is then rolled along the belt 291 to the output tray 285.

The laser printer 270 also includes a controller 290 that is able to receive data from and outside source, e.g., the personal computer 200, store the data in a printing buffer (not shown) and the interpret the data (which corresponds to a document) into an electrostatic image to be imparted by the laser 284. The controller 290 typically communicates with the computer system 200 via standard, well-known protocols such as through parallel communications ports and/or universal serial bus ports, i.e., output peripheral interface 250.

FIG. 3 is a diagram of a portion of the laser printer 270 of FIG. 2 in the process of imparting toner to a sheet of paper 300 according to an embodiment of the invention. A sheet of paper 300 is shown moving through a portion of the laser printer 270. Accordingly, different portions of the sheet of paper 300 are in different printing states, i.e., empty at the bottom, toner applied but not fused yet in the middle, and toner fused at the top. When the paper 300 is first staged to be printed, the laser 284 is focused, via the focusing mirror system 283, across the surface of the rotating drum 281 to discharge certain points according to the specific pattern. Thus, the laser 284 imparts an electrostatic image to the surface of the rotating drum 281.

After the electrostatic image is imparted to the rotating drum 281, the rotating drum 281 is coated with positively charged toner from the toner roller 282. Since the toner has a positive charge, the toner clings to the negative discharged areas of the rotating drum 281, but not to the positively charged areas.

With the toner pattern applied according to the electrostatic image, the rotating drum 281 continues rotating and rolls over a sheet of paper 300. As described above, before the paper 300 rolls under the rotating drum 281, it is imparted with a negative charge. The negative charge imparted to the paper 300 is stronger than the negative charge of the electrostatic image imparted the rotating drum 281 by the laser 284. Thus, when the paper 300 engages the rotating drum 281, the positively charged toner is then attracted to the more negatively charged paper 300, in essence, transferring the electrostatic image from the rotating drum 281 to the paper. The paper 300, now having toner applied according to the electrostatic image, passes through a fuser 286. As the paper passes through the fuser 286, the loose toner powder melts, fusing with the fibers in the paper.

The toner in the toner roller 282 may be supplied from one or more toner hoppers. The embodiment of FIG. 3 shows three toner hoppers: a black toner hopper 310, a color toner hopper 311, and a clear toner hopper 312. The particular hopper required for a printing job may be chosen through the controller 290 (not shown in FIG. 3) via a toner selector mechanism 315.

The choice of toner depends upon the nature of the printing job. Typically, black and colored toner (examples of non-effect and non-finish toners) may be imparted to a sheet of paper 300 in conventional ways to print underlying document patterns, i.e., images and words. According to various embodiments of the invention, an effect or finish toner, such as clear toner, may be imparted to a sheet of paper to create particular document effects and finishes.

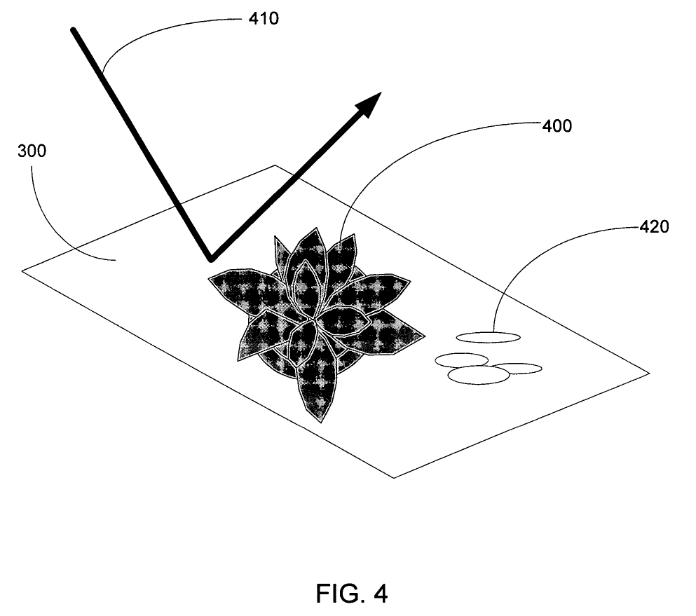

For example, a sheet of paper 300 may first be printed using black toner from the black toner hopper 310. Then, a particular effect, such as water-resistant sealing, may be achieved by applying a coating of clear toner from the clear toner hopper 312 across the entire sheet of paper 300 on a second pass through the laser printer 270. The resulting document is a printed document with images or words in black toner underneath a water-resistant coating of clear toner. This document effect and others are described in greater detail below with respect to FIG. 4.

In one embodiment of the invention, the printer 270 is operable to create document effects such that paper 300 is passed by the rotating drum 281 twice. For example, a first pass may impart underlying document content and/or images. Then after the underlying toner (black or colored) is fused to the paper 300 at the end of the first pass, the paper 300 may be fed back for a second pass for imparting additional toner for document effects. Thus, in the second pass, a particular pattern of clear toner is imparted and fused to the paper 300 such that the finished document has a first pattern of black or colored toner underneath a pattern of clear toner fashioned to achieve a particular document effect.

In another embodiment of the invention, a printer (not shown in any figure) is operable to create document having effects such that the printer includes two stages for imparting toner to a sheet of paper 300. For example, a first stage may impart underlying document content and/or images. Then after the underlying toner (black or colored) is fused to the paper 300 at the end of the first stage, the paper 300 may be fed to a second stage for imparting additional toner for document effects. Thus, in the second stage, a particular pattern of clear toner may be imparted and fused to the paper 300 such that the finished document has a first pattern of black or colored toner underneath a pattern of clear toner fashioned to achieve a particular document effect.

Clear toner may be imparted to a sheet of paper 300 to create a number of different document effects according to various aspects of the invention. Such document effects include watermarking, water-resistant coating, UV protection, and others and are discussed below with respect to FIG. 4. Additionally, the toner may be translucent or semi-transparent in order to achieve other document effects and/or document finishes.

FIG. 4 is an isometric view of a sheet of paper 300 having underlying content and document effects that me be printed using the printer 270 of FIG. 2 according to an embodiment of the invention. The sheet of paper 300 includes underlying content, such as an image of a flower 400, which has been fused to the paper 300 in black and/or colored ink as well as a document effect, such as a water-resistant coating, that has been fused to the paper 300 in a clear toner. Of course, the document effects cannot be seen precisely in FIG. 4 because the toner is clear. However, the physical effects of the clear toner may be illustrated.

For example, as described above, the paper 300 may have a water-resistant coating fused to it. Thus, water 420 will not penetrate the paper 300 and will bead up as shown in FIG. 4. Such a water-resistant coating may be fused over the entire sheet of paper 300 using a clear toner specifically designed to be water-resistant. As a result, the underlying image 400 may still be seen through the clear toner that covers the entire sheet of paper 300 to provide a water-resistant coating.

In another example, the paper 300 may have a UV reflective coating fused to it. Thus, UV rays 410 will be reflected by the UV reflective coating on the paper 300 as shown in FIG. 4. Such a UV reflective coating may be fused over the entire sheet of paper 300 using a clear toner specifically designed to be UV reflective. As a result, the underlying image 400 may still be seen through the clear toner that covers the entire sheet of paper 300 to provide a protection against fading and discoloration due to UV light exposure.

In another embodiment of the invention, another effect toner, such as translucent toner (not shown), may be imparted and fused to the sheet of paper 300 to provide additional document effects. For example, certain artistic effects may be achieved by using translucent toner, such as watermarking effects, 3-D effects, and holography.

Watermarking is an effect whereby a see-through image appears over the top of an underlying image 400. Thus, according to an embodiment of the invention, the underlying image may be fused to the paper 300 using black and/or colored toner and then a superimposed second image, meant to be transparent or semi-transparent, may be fused to the sheet of paper 300 using translucent and/or clear toner.

A 3-D effect is an optical illusion effect whereby an image 400 appears to be “jumping” out of a page when viewed using a specially-prepared viewer, e.g., 3-D glasses. Thus, according to an embodiment of the invention, the underlying image 400 may be again fused to the paper 300 using black and/or colored toner and then a slightly different second image, meant to be transparent or semi-transparent when viewed without the 3-D viewer, may be fused to the sheet of paper 300 using translucent and/or clear toner. Then, when the underlying image is viewed without the 3-D viewer, the image 400 appears incomprehensible or out of focus, but when the 3D viewer is used, the image appears to be lifted off of the paper 300.

A holographic effect is another optical illusion effect whereby an image 400 appears to have depth into a page when viewed. Thus, according to an embodiment of the invention, the underlying image 400 may be again fused to the paper 300 using black and/or colored toner and then a slightly different second image, meant to be transparent or semi-transparent, may be fused to the sheet of paper 300 using translucent and/or clear toner. Then, when the underlying image 400 is viewed the image appears to have depth as if one could reach down into the image.

Other artistic effects may also be created using clear or translucent toner as well as varying sizes of toner particles within the blend of toner. Such artistic effects include glossy, matte, or satin finishes. By mixing a particular blend of sizes of particles of clear toner or translucent toner, different finish effects may be created when imparted to a sheet of paper 300. That is, the consistency of the toner may be varied from fine to course in order to achieve different document effects in addition to varying the color and/or transparency of the toner.

For example, applying a certain blend of clear toner to a sheet of paper 300 may impart a glossy finish effect to the underlying image 400. Likewise, applying a different blend of clear toner and/or translucent toner may impart a matte finish effect to the underlying image 400. Further yet, applying yet another different blend of clear toner and/or translucent toner may impart a satin finish effect to the underlying image 400. Other finish effects are contemplated but not disclosed in greater detail herein.

We claim:

1. A method for printing a document, the method comprising:
determining an electrostatic image to be applied to a sheet of paper that corresponds to an effects pattern;
applying an effect toner to the sheet of paper according to the electrostatic image, the effect toner operable to yield a document effect that corresponds to the effects pattern when fused to the sheet of paper; and
fusing the effect toner to the sheet of paper.

2. The method of claim 1 wherein the effects pattern comprises a holographic effects pattern.

3. The method of claim 1 wherein the effects pattern comprises a three-dimensional effects pattern.

4. The method of claim 1 wherein the effects pattern comprises a watermarking effects pattern.

5. The method of claim 1 wherein the effects pattern comprises a distribution of effect toner operable to reflect ultra-violet light rays away from the sheet of paper.

6. The method of claim 1 wherein the effects pattern comprises a distribution of effect toner operable to make the sheet of paper water resistant.

7. The method of claim 1, further comprising:
determining an electrostatic image to be applied to a sheet of paper that corresponds to a document pattern; and
applying non-effect toner to the sheet of paper according to the electrostatic image that corresponds to the document pattern.

8. The method of claim 7 wherein the non-effect toner is fused to the sheet of paper prior to applying the effect toner to the sheet of paper.

9. The method of claim 1, further comprising:
determining an electrostatic image to be applied to a sheet of paper that corresponds to a document pattern; and
applying non-effect ink to the sheet of paper according to the electrostatic image that corresponds to the document pattern.

10. The method of claim 1, wherein the effect toner comprises a clear effect toner.

11. The method of claim 1, wherein the effect toner comprises a translucent effect toner.

12. A method for printing a document, the method comprising:
determining an electrostatic image to be applied to a sheet of paper that corresponds to an effects pattern;
applying a blend of effect toners, to the sheet of paper according to the electrostatic image, the blend including at least a translucent toner and a clear toner; and
fusing the blend of effect toners to the sheet of paper.

13. The method of claim 12 wherein the effects pattern comprises a holographic effects pattern:

14. The method of claim 12 wherein the effects pattern comprises a three-dimensional effects pattern.

15. The method of claim 12 wherein the effects pattern comprises a watermarking effects pattern.

16. The method of claim 12, further comprising:
determining an electrostatic image to be applied to a sheet of paper that corresponds to a document pattern;
applying non-effect toner to the sheet of paper according to the electrostatic image that corresponds to the document pattern; and
fusing the non-effect toner to the sheet of paper prior to applying the effect toner.

17. A printer having a print stage, comprising:
a laser operable to impart an electrostatic image to a rotating drum, the electrostatic image corresponding to an effects pattern;
a toner roller operable to impart an effect toner to the rotating drum according to the electrostatic image;
a belt system operable to maneuver a sheet of paper toward the rotating drum such that the rotating drum imparts the effect toner to the paper according to the electrostatic image; and
a fuser operable to fuse the effect toner to the sheet of paper.

18. The printer of claim 17 wherein the belt maneuvers the sheet of paper from a paper tray.

19. The printer of claim 17 wherein the laser imparts the electrostatic image to the rotating drum via focusing mirror system.

20. The printer of claim 17, further comprising a printer controller operable to control the laser and operable to receive a print command from a computer system via a communication port.

21. The printer of claim 17, further comprising a charge corona wire operable to impart a negative charge to the rotating drum.

22. The printer of claim 17, further comprising a discharge lamp operable to impart a positive charge to the rotating drum.

23. The printer of claim 17, further comprising a transfer corona wire operable to impart a negative charge to the paper.

24. The printer of claim 23, further comprising a detac transfer corona wire operable to discharge the negative charge from the paper after the paper has passed the rotating drum.

25. The printer of claim 17, further comprising a second print stage including:
a second laser operable to impart a second electrostatic image to a second rotating drum, the second electrostatic image corresponding to an image pattern;
a second toner roller operable to impart non-effect toner to the second rotating drum according to the second electrostatic image;
a second belt system operable to maneuver a sheet of paper toward the second rotating drum such that the second rotating drum imparts the non-effect toner to the paper according to the second electrostatic image; and
a second fuser operable to fuse the non-effect toner to the sheet of paper.
